(19) United States
(12) Patent Application Publication
(10) Pub. No.: US 2018/0086159 A1
(43) Pub. Date: Mar. 29, 2018

(54) TIRE READY TO RECEIVE A MEMBER ON THE SURFACE THEREOF

(71) Applicant: COMPAGNIE GENERALE DES ETABLISSEMENTS MICHELIN, CHERMONT-FERRAND (FR)

(72) Inventor: VINCENT LEMAL, Clermont-Ferrand (FR)

(21) Appl. No.: 15/567,801

(22) PCT Filed: Apr. 5, 2016
(86) PCT No.: PCT/EP2016/057441

§ 371 Date: Oct. 19, 2017

(30) Foreign Application Priority Data
Apr. 20, 2015 (FR) 1553512

(51) Int. Cl. B60C 23/04; B32B 7/06; B32B 7/12; B32B 25/04; B32B 25/16; B29D 30/00; C09J 153/02

(52) U.S. Cl. CPC B60C 23/0493; B32B 7/06; B32B 7/12; B32B 25/042; C09J 2205/114; B29D 30/0061; C09J 153/02; B32B 2605/00; B29D 2030/0077; B32B 25/16

(57) ABSTRACT

A tire comprises an inner surface and/or outer surface with an accommodating region, an adhesive layer arranged on the accommodating region and a protective film arranged on said adhesive layer. The adhesive layer is based on a block thermoplastic styrene (TPS) elastomer comprising an elastomer block based on a diene elastomer comprising a molar content (or content by weight) of unsaturations of greater than 10%, and the adhesive layer comprises one or more polyphenylene ethers (PPEs).

### TECHNICAL FIELD

The present invention relates to tyres, and more particularly to tyres ready to receive a member, for example an electronic member, attached to the inner and/or outer surface thereof.

### PRIOR ART

The recent development of systems for monitoring tyres of a running vehicle (“Tyre Pressure Monitoring Systems” or “TPMSs”) is limited by the difficulty of rapidly and durably attaching an object to the surface of a tyre.

Document US 2012/0248274 proposes a tyre comprising an inner and/or outer surface with an accommodating region, an adhesive layer arranged on this accommodating region and a protective film arranged on the adhesive layer, in which the adhesive layer consists of a fabric embedded in a thermoplastic material. After having removed the protective film from the surface of the adhesive layer, the adhesive layer of the accommodating region of the tyre and the attachment layer of the member are brought into contact. The presence of the fabric ensures stable attachment of the adhesive layer to the surface of the tyre during the vulcanization of the tyre. The attachment layer of the member also consists of a thermoplastic material and the reversible attachment of the member to the surface of the tyre is ensured by bringing the two layers, adhesive layer and attachment layer, into contact after softening thereof by heating.

This document gives no indication as to the nature of the thermoplastic materials which may be used.

### BRIEF DESCRIPTION OF THE INVENTION

A subject of the invention is a similar tyre, characterized in that the composition of the adhesive layer is based on a block thermoplastic styrene (TPS) elastomer comprising a diene elastomer block with a molar content of diene units relative to all of the units of the elastomer block of greater than 10%, and in that the composition of the adhesive layer comprises one or more polyphenylene ethers (PPEs).

The use of such an adhesive layer has the advantage of enabling cocrosslinking of the adhesive layer and the rubber material of the tyre's inner or outer surface during the vulcanization of the tyre by virtue of the presence of the double bonds present in the diene elastomers. The adhesive layer is thus bound stably and durably to the surface of the tyre by cocrosslinking and makes it possible to dispense with the presence of a fabric. The presence of the polyphenylene ether makes it possible to very surprisingly improve the hot adhesion of the adhesive layer to the surface of the tyre under working conditions, that is to say with maximum temperatures of the order of 100° C.

Another subject of the invention is a member intended to be attached to the surface of a tyre, characterized in that this member comprises an attachment layer, the composition of which is based on a block thermoplastic styrene (TPS) elastomer.

In addition, according to a preferential embodiment, the block thermoplastic styrene elastomer of the attachment layer is identical to the block thermoplastic styrene elastomer of the adhesive layer.

Moreover, this method of attachment affords a high degree of freedom as regards the geometry and functions of the member, due to the attachment post-vulcanization.

The member may be a casing able to receive an electronic device.

The member may also be an electronic device.

It may also especially be a marking or a decoration.

Another subject of the invention is an assembly comprising a tyre with a member attached to the surface thereof by the adhesive layer bound to the attachment layer.

Another subject of the invention is a method for attaching a member with an attachment layer to the surface of a tyre with an adhesive layer protected by a protective film arranged on an accommodating region, in which:
all or a portion of the protective film is removed;
said adhesive layer and said attachment layer are brought to a temperature greater than the softening points or Tg (or M.p., if appropriate) of said block thermoplastic elastomers; and
the attachment layer and the adhesive layer are brought into contact with application of pressure thereto.

The member is thus attached very rapidly and very simply. The attachment is effective and durable as soon as the temperatures of the adhesive layer and attachment layer have returned below the softening points or Tg (or M.p., if appropriate) of the TPSs. It also has the advantage of being entirely reversible.

The invention relates more particularly to the tyres intended to equip motor vehicles of passenger vehicle, SUV (“Sport Utility Vehicle”), two-wheel vehicle (especially motorcycle) or aircraft type, and industrial vehicles chosen from vans, heavy-duty vehicles, that is to say, underground trains, buses, heavy road transport vehicles (lorries, tractors, trailers) or off-road vehicles, such as heavy agricultural vehicles or earthmoving equipment, and other transportation or handling vehicles.

### DETAILED DESCRIPTION OF THE INVENTION

In the present description, unless expressly indicated otherwise, all the percentages (%) shown are % by weight.

“One” or “a” is intended to mean “one or more”; by way of example, “a thermoplastic elastomer” is equivalent to “one or more thermoplastic elastomers”. Similarly, “one” or “a polyphenylene ether” is equivalent to “one or more polyphenylene ethers”.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

The details of the invention will be explained below by the description, firstly, of the specific constituents of the tyre according to one of the subjects of the invention, then by the description of the method of manufacture of the tyre and the characterization tests carried out.

The tyre according to the invention has the essential features of being provided, at a given accommodating region of the surface thereof, with an adhesive layer comprising a thermoplastic styrene elastomer and a polyphenylene ether, the adhesive layer being protected by a protective film, as are defined below.

### Thermoplastic Styrene Elastomer

Thermoplastic elastomers (abbreviated to TPEs) have a structure intermediate between elastomers and thermoplastic polymers. They consist of rigid thermoplastic sequences connected by flexible elastomer sequences, for example polybutadiene, polyisoprene, poly(ethylene/butylene) or else polyisobutylene. They are often triblock elastomers with two rigid segments connected by a flexible segment. The rigid and flexible segments can be positioned linearly, or in a star-branched or branched configuration. Typically, each of these segments or blocks contains at least more than 5, generally more than 10, base units (for example, styrene units and isoprene units for a styrene/isoprene/styrene block copolymer).

Thermoplastic elastomers (abbreviated to TPEs) have a structure intermediate between elastomers and thermoplastic polymers. These are block copolymers consisting of rigid thermoplastic blocks connected via flexible elastomer blocks.

### Nature of the Thermoplastic Blocks

Use will be made, for the definition of the thermoplastic blocks, of the characteristic of glass transition temperature (Tg) of the rigid thermoplastic block. This characteristic is well known to those skilled in the art. It especially makes it possible to choose the industrial processing (transformation) temperature. In the case of an amorphous polymer (or polymer block), the processing temperature is chosen to be substantially greater than the Tg of the thermoplastic block. In the specific case of a semicrystalline polymer (or polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference is made to “Tg (or M.p., if appropriate)”, this will have to be considered to be the temperature used to choose the processing temperature.

It is also possible to consider the softening point of the TPEs. This softening point is close to the processing temperature. In order to determine it, it is possible, for example, to subject a sample to a fixed compressive stress, place the sample in an oven making it possible to carry out a temperature ramp from room temperature to a given temperature, of the order of the maximum curing temperature (for example: 180° C.), with given kinetics, during which the deformation of the sample is recorded. The results are in the form of a curve of deformation of the sample as a function of temperature; the softening point is usually considered to be that for which the material has a reduction in its thickness of 10%.

The thermoplastic elastomer according to one subject of the invention is characterized in that it is selected from thermoplastic styrene (TPS) elastomers. Styrene monomer should be understood as meaning, in the present description, any monomer based on styrene, unsubstituted or substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene), para-hydroxystyrene or else halomethylstyrenes (for example p-chloromethyl styrene or p-bromomethylstyrene).

### Structure of the TPS

The number-average molecular weight (denoted Mn) of the TPS is preferentially less than 500 000 g/mol, more preferentially less than 400 000 g/mol. This is because too high an Mn may be detrimental to the adhesive bonding of the member or to the use of the TPS. As regards the minimum value, it has been observed that the presence of low Mn weights (less than 30 000 g/mol) may be favourable for the adhesive bonding of the sensor. This may be obtained by a TPS with a broad distribution of molecular weights Mn, or by mixing several TPSs with suitable molecular weights.

The number-average molecular weight (Mn) of the TPS elastomer is determined in a known way by size exclusion chromatography (SEC). For example, in the case of styrene thermoplastic elastomers, the sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, EIMW6E and two HT6Es), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards. The conditions can be adjusted by those skilled in the art.

In order to be both elastomeric and thermoplastic in nature, the TPS has to be composed of blocks which are sufficiently incompatible (that is to say, different as a result of their respective weights, their respective polarities or their respective Tg values) to retain their own properties of elastomer block or thermoplastic block.

The TPSs can be copolymers with a small number of blocks (less than 5, typically 2 or 3), in which case these blocks preferably have high weights of greater than 15 000 g/mol. These TPSs may for example be mixtures of diblock copolymers, comprising a thermoplastic block and an elastomer block, and of triblock copolymers with two rigid segments connected by a flexible segment. These mixtures may be predominantly diblock or triblock. It is usually possible to have a triblock content of between 60% and 80%. The rigid and flexible segments can be positioned linearly, or in a star-branched or branched configuration. Typically, each of these segments or blocks often comprises a minimum of more than 5, generally of more than 10, base units (for example, styrene units and butadiene units for a styrene/butadiene/styrene block copolymer).

The TPSs can also comprise a large number of smaller blocks (more than 30, typically from 50 to 500), in which case these blocks preferably have relatively low weights, for example from 500 to 5000 g/mol; these TPSs will subsequently be referred to as multiblock TPSs and are an elastomer block/thermoplastic block series.

According to a first variant, the TPS is provided in a linear form. For example, the TPS is a mixture of diblock copolymer: thermoplastic block/elastomer block, and of triblock copolymer: thermoplastic block/elastomer block/thermoplastic block, that is to say a central elastomer block and two terminal thermoplastic blocks, at each of the two ends of the elastomer block. Equally, the multiblock TPS can be a linear series of elastomer blocks/thermoplastic blocks. The TPSs according to this variant are favourable for good adhesion of the member.

According to another variant of the invention, the TPS of use for the requirements of the invention is provided in a star-branched form comprising at least three branches. For example, the TPS can then be composed of a star-branched elastomer block comprising at least three branches and of a thermoplastic block located at the end of each of the branches of the elastomer block. The number of branches of the central elastomer can vary, for example, from 3 to 12 and preferably from 3 to 6. This TPS variant is favourable for good temperature resistance.

According to another variant of the invention, the TPS is provided in a branched or dendrimer form. The TPS can then be composed of a branched or dendrimer elastomer block and of a thermoplastic block located at the end of the branches of the dendrimer elastomer block.

### Nature of the Elastomer Blocks

The elastomer blocks of the TPS for the requirements of the invention can be any unsaturated diene elastomers known to those skilled in the art. They generally have a Tg of less than 25° C., preferably of less than 10° C., more preferentially of less than 0° C. and very preferentially of less than −10° C. Also preferentially, the Tg of the elastomer block of the TPS is greater than −100° C.

A “diene” elastomer (or rubber, the terms being used interchangeably) should be understood, in a known way, as an (or several) elastomer(s) consisting at least in part (i.e., a homopolymer or a copolymer) of diene monomer units (monomers bearing two conjugated or unconjugated carbon-carbon double bonds).

These diene elastomers can be classified into two categories: “unsaturated” or “saturated”. “Essentially unsaturated” is generally intended to mean a diene elastomer resulting at least in part from conjugated diene monomers having a content of unsaturations or of units of diene origin (conjugated dienes) which is greater than 10% (mol %); thus, diene elastomers such as butyl rubbers do not fall under the preceding definition and can especially be described as “saturated” diene elastomers (low or very low molar content, for example of the order of 4%, always less than 10%, of units of diene origin). In the category of the “unsaturated” diene elastomers which may be used for the invention, all the diene elastomers having a molar content of unsaturations or of units of diene origin (conjugated dienes) of greater than 10%, and in particular the “highly unsaturated” diene elastomers, that is to say the diene elastomers having a molar content of unsaturations or of units of diene origin (conjugated dienes) which is greater than 50%, are thus intended.

“Unsaturated diene elastomer able to be used in the elastomer blocks in accordance with the invention” is more particularly intended to mean:
(a) any homopolymer of a conjugated diene monomer, especially any homopolymer obtained by polymerization of a conjugated diene monomer having from 4 to 12 carbon atoms; and
(b) any copolymer obtained by copolymerization of one or more conjugated dienes with one another or with one or more vinylaromatic compounds having from 8 to 20 carbon atoms.

In the case of copolymers of the type (b), the latter contain from 20% to 99% by weight of diene units and from 1% to 80% by weight of vinylaromatic units.

The following are especially suitable as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene.

The following, for example, are suitable as vinylaromatic compounds: styrene, ortho-, meta- or para-methyl styrene, the “vinyltoluene” commercial mixture, para-(tert-butyl)styrene, methoxystyrenes, chlorostyrenes, vinylmesitylene, divinylbenzene or vinylnaphthalene.

According to a preferential embodiment of the invention, the elastomer blocks of the TPS have, in total, a number-average molecular weight (Mn) ranging from 25 000 g/mol to 350 000 g/mol, preferably from 35 000 g/mol to 250 000 g/mol, so as to confer, on the TPS, good elastomer properties and a mechanical strength which is sufficient and compatible with the use as adhesive layer for the attachment of a member to the surface of a tyre.

The elastomer block can also be a block comprising several types of ethylene, diene or styrene monomers as defined above.

The elastomer block can also consist of several elastomer blocks as defined above.

The microstructure of the elastomers is determined by ¹H NMR analysis, supplemented by ¹³C NMR analysis when the resolution of the ¹H NMR spectra does not enable the attribution and quantification of all the species. The measurements are carried out using a Bruker 500 MHz NMR spectrometer at frequencies of 500.43 MHz for observing protons and 125.83 MHz for observing carbons.

For the measurements of mixtures or elastomers which are insoluble but which have the ability to swell in a solvent, an HRMAS z-grad 4 mm probe is used, making it possible to observe protons and carbons in proton-decoupled mode. The spectra are acquired at spin speeds of 4000 Hz to 5000 Hz.

For the measurements of soluble elastomers, a liquid NMR probe is used, making it possible to observe protons and carbons in proton-decoupled mode.

The insoluble samples are prepared in rotors filled with the analyte and a deuterated solvent enabling swelling, in general deuterated chloroform (CDCl₃). The solvent used must always be deuterated and its chemical nature may be adapted by those skilled in the art. The amounts of material used are adjusted so as to obtain spectra with sufficient sensitivity and resolution.

The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by those skilled in the art.

In both cases (soluble sample or swollen sample):

For the proton NMR, a simple 30° pulse sequence is used. The spectral window is adjusted to observe all the resonance lines belonging to the molecules analysed. The accumulation number is adjusted in order to obtain a signal to noise ratio that is sufficient for the quantification of each unit. The recycle period between each pulse is adapted to obtain a quantitative measurement.

For the carbon NMR, a simple 30° pulse sequence is used with proton decoupling only during acquisition to avoid the “nuclear Overhauser” effects (NOEs) and to remain quantitative. The spectral window is adjusted to observe all the resonance lines belonging to the molecules analysed. The accumulation number is adjusted in order to obtain a signal to noise ratio that is sufficient for the quantification of each unit. The recycle period between each pulse is adapted to obtain a quantitative measurement.

The measurements are carried out at 25° C.

### Nature of the Thermoplastic Blocks

The polystyrenes are obtained from styrene monomers. Styrene monomer should be understood as meaning, in the present description, any monomer comprising styrene, unsubstituted or substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene), para-hydroxystyrene or else halomethylstyrenes (for example p-chloromethyl styrene or p-bromomethylstyrene).

### Examples of TPSs

The TPS of the adhesive layer of the tyre according to the invention is a copolymer the elastomer part of which is unsaturated and which comprises diene blocks and advantageously styrene blocks, these diene blocks being in particular isoprene or butadiene blocks. More preferentially, this TPS elastomer is selected from the following group consisting of diblock or triblock copolymers which are linear or star-branched: styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS) and the mixtures of these copolymers.

For example again, the TPS is a linear or star-branched copolymer, the elastomer part of which comprises a saturated part and an unsaturated part, such as, for example, styrene/butadiene/butylene (SBB), styrene/butadiene/butylene/styrene (SBBS) or a mixture of these copolymers.

By way of examples of commercially available TPS elastomers, mention may be made of the elastomers of SIS type sold by Kuraray under the name Hybrar 5125 or sold by Kraton under the name D1161, or else the elastomers of linear SBS type sold by Polimeri Europa under the name Europrene SOLT 166 or of star-branched SBS type sold by Kraton under the name D1184. Mention may also be made of the elastomers sold by Dexco Polymers under the name Vector (e.g. Vector 4114 or Vector 8508).

### Polyphenylene Ether (PPE)

The composition of the adhesive layer has another essential feature of comprising, in combination with the TPS elastomer described above, at least one polyphenylene ether (abbreviated to PPE).

PPEs are well known to those skilled in the art; they are resins which are solid at room temperature (23° C.) and which are compatible with styrene polymers, which are especially used to increase the Tg of TPS elastomers (see, for example, “Thermal, Mechanical and Morphological Analyses of Poly(2,6-dimethyl-1,4-phenylene oxide)/Styrene-Butadiene-Styrene Blends”, Tucker, Barlow and Paul, Macromolecules, 1988, 21, 1678-1685).

Preferentially, the PPE used here has a glass transition temperature (denoted hereinafter by Tg) which is greater than 150° C., more preferentially greater than 180° C. As regards its number-average molecular weight (Mn), it is preferentially between 5000 and 100 000 g/mol.

The number-average molecular weight (Mn) is determined, in a known manner, by size exclusion chromatography (SEC). The sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four WATERS columns in series, with the Styragel trade names (HMW7, HMW6E and two HT6Es), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

Mention may especially be made, as non-limiting examples of PPE polymers which can be used in the airtight composition according to one subject of the invention, of those selected from the group consisting of poly(2,6-dimethyl-1,4-phenylene ether), poly(2,6-dimethyl-co-2,3,6-trimethyl-1,4-phenylene ether), poly-(2,3,6-trimethyl-1,4-phenylene ether), poly(2,6-diethyl-1,4-phenylene ether), poly(2-methyl-6-ethyl-1,4-phenylene ether), poly(2-methyl-6-propyl-1,4-phenylene ether), poly(2,6-dipropyl-1,4-phenylene ether), poly(2-ethyl-6-propyl-1,4-phenylene ether), poly(2,6-dilauryl-1,4-phenylene ether), poly(2,6-diphenyl-1,4-phenylene ether), poly(2,6-dimethoxy-1,4-phenylene ether), poly(1,6-diethoxy-1,4-phenylene ether), poly(2-methoxy-6-ethoxy-1,4-phenylene ether), poly(2-ethyl-6-stearyloxy-1,4-phenylene ether), poly(2,6-dichloro-1,4-phenylene ether), poly(2-methyl-6-phenyl-1,4-phenylene ether), poly(2-ethoxy-1,4-phenylene ether), poly(2-chloro-1,4-phenylene ether), poly(2,6-dibromo-1,4-phenylene ether), poly(3-bromo-2,6-dimethyl-1,4-phenylene ether), their respective copolymers and the mixtures of these homopolymers or copolymers.

According to a particular and preferential embodiment, the PPE used is poly(2,6-dimethyl-1,4-phenylene ether). Such commercially available PPEs are, for example, Xyron S202 from Asahi Kasei or Noryl SA120 from Sabic.

In the composition of the adhesive layer, the amount of PPE polymer is preferably adjusted so that the weight content of PPE is between 0.05 and 5 times, more preferentially between 0.1 and 2 times, the weight content of styrene present in the block thermoplastic styrene elastomer. Below the recommended minimal values, there is no visible effect of the presence of PPE, and above 5 times, too great an increase in the rigidity of the adhesive layer is observed.

For all these reasons, the weight content of PPE is more preferentially still between 0.2 and 1.5 times the weight content of styrene in the block thermoplastic styrene elastomer.

Weight content of polyphenylene ether is intended to mean the weight of the polyphenylene ether(s) in the composition per 100 g of the TPS(s).

Likewise, the weight content of styrene corresponds to the weight of substituted or unsubstituted styrene units in the TPS(s) per 100 g of the TPS(s).

### Protective Film

The protective film must be a flexible, heat-resistant film which must also have limited adhesion to the adhesive layer, in order to be removable therefrom. The force of peeling the film from the adhesive layer is preferably less than 1 N/mm at 20° C., and very preferentially less than 0.5 N/mm.

This film makes it possible to protect the surface of the adhesive layer during operations for assembling the tyre and the vulcanization thereof in a mould.

It may especially be a thermoplastic film. This thermoplastic film is advantageously selected from the group consisting of polyesters and films comprising at least one fluoropolymer. Those skilled in the art will know how to choose the thickness thereof in order to obtain the best compromise between the flexibility and mechanical strength thereof. This thickness is advantageously between 10 and 300 μm.

The nature of the protective film may be incompatible with that of the TPS of the adhesive layer, in order to obtain a suitable limited adhesion.

In a preferential use, this film is removed just before placing the member on the surface of the tyre, in order to avoid any fouling of the surface of the adhesive layer. The film therefore has the advantage of protecting the adhesive layer during all the phases of transportation and storage of the tyres.

Preferably, the Tg (or M.p., if appropriate) of the protective film is greater than the curing temperature of the rubber mixture of the accommodating region of the surface of the tyre. A temperature of 200° C. for the Tg (or M.p., if appropriate) enables the film to withstand the usual temperatures for vulcanization of passenger vehicle tyres.

As an example of polyester film, use may be made of the films sold under the brand name Mylar with a thickness of between 0.03 and 0.2 mm. Such a polyester film has a melting point of greater than 230° C.

Fluorinated ethylene/propylene (FEP) copolymers may be chosen as fluoropolymers. Advantageously, the film comprises a copolymer of tetrafluoroethylene (TFE) and hexafluoropropylene (HFP).

These polymers have noteworthy anti-stick properties.

An example of a suitable film is the A5000 film from Aerovac Systèmes France. This film comprises a fluorinated ethylene/propylene or FEP copolymer. This film has a maximum usage temperature of the order of 204° C. and an elongation at break of greater than 300%. The thickness thereof is 25 μm. These features enable it to be placed directly on the building drum of the pneumatic tyre, in the specific case of accommodating region placed on the inner rubber surface of the tyre.

The following table gives examples of films which are suitable for the invention.

| Name | Supplier | Type | Thickness | | T max | Elongation |
|---|---|---|---|---|---|---|
| A5000 | Aerovac | FEP | 25 | μm | 260° C. | >300% |
| A6000 | Aerovac | ETFE | 12, 15 and 20 | μm | 230° C. | >200% |
| MR Film | Aerovac | PTFE | 25 | μm | 315° C. | >550% |
| FEP100 | Dupont | FEP | 25 | μm | 260° C. | >300% |
| FEP100 | Dupont | FEP | 12.5 | μm | 260° C. | >300% |
| Norton | Saint | FEP | 25 | μm | 260° C. | >300% |
| FEP 0.001 | Gobain | | | | | |
| Norton | Saint | FEP | 12.5 | μm | 260° C. | >300% |
| FEP 0.0005 | Gobain | | | | | |

The protective film makes it possible to separate the adhesive layer from any contact with the building drum of the pneumatic tyre then with the curing membrane of the vulcanization mould. The incompatible nature of the protective film relative to the adhesive layer enables it to be removed from the inner surface of the pneumatic tyre after vulcanization. The removal of this protective film restores to the adhesive layer all the properties of the latter. The protective film may be removed without tearing.

### Composition of the Adhesive Layer of the Tyre

The adhesive layer of the tyre according to the invention has the essential feature of comprising a block thermoplastic styrene (TPS) elastomer.

The term “one” or “a” must be understood as “at least one”, that is to say one or more block thermoplastic elastomers. By way of example, it is advantageous to use a mixture of TPSs, one of which has a number-average molecular weight Mn which is suitable for good temperature resistance, and a TPS with a low weight Mn to promote good adhesive bonding between the adhesive layer of the tyre and the attachment layer of the member.

One or more TPS elastomers alone may form an adhesive layer composition of the tyre.

The weight content of polyphenylene ether in the adhesive composition preferably represents between 0.05 and 5 times the weight content of styrene present in the thermoplastic styrene elastomer of the adhesive composition.

Very preferentially, the weight content of polyphenylene ether represents between 0.1 and 2 times and very very preferentially between 0.2 and 1.5 times the weight content of styrene present in the thermoplastic styrene elastomer.

The presence of the polyphenylene ether in the adhesive composition should increase the temperature-related viscosity of the adhesive composition and hence detrimentally affect the interpenetration of the adhesive layer and of the rubber layer of the tyre surface, limiting the adhesion of these two layers. However, very surprisingly, on the contrary an improvement in adhesion at working temperatures of less than 100° C. is observed.

In a minor amount, the composition of the adhesive layer may comprise a customary diene elastomer such as an SBR, a polybutadiene or a natural or synthetic polyisoprene. Very preferentially, the content of diene elastomer in the composition is less than 20 parts per hundred parts by weight of elastomers of the composition (phr). Of course, the TPE(s) of the composition are taken into account in the elastomers of the composition.

Moreover, according to a preferential embodiment of the invention, the composition of the adhesive layer may also comprise, as plasticizing agent, an extender oil (or plasticizing oil), the function of which is to facilitate the joining of the adhesive layer and the attachment layer of the member, particularly by lowering the modulus and increasing the tackifying power.

Use may be made of any extender oil having a weakly polar nature, capable of extending or plasticizing elastomers, especially thermoplastic elastomers. At room temperature (23° C.), these oils, which are more or less viscous, are liquid (that is to say, as a reminder, substances which have the ability to eventually assume the shape of their container), in contrast especially to resins or rubbers, which are by nature solid.

Preferably, the extender oil is selected from the group consisting of polyolefinic oils (that is to say, oils resulting from the polymerization of monoolefinic or diolefinic olefins), paraffinic oils, naphthenic oils (of low or high viscosity), aromatic oils, mineral oils and the mixtures of these oils. Those skilled in the art will know how to adjust the nature and amount of extender oil as a function of the particular conditions of use of the adhesive layer.

An oil of liquid isoprene rubber (LIR) type is preferentially used. By way of example, LIR 30 and LIR 50, with number-average molecular weights of 30 000 and 50 000 g/mol, respectively, are sold by Kuraray.

The composition of the adhesive layer may moreover comprise the various additives customarily present in compositions based on block thermoplastic elastomers known to those skilled in the art. Mention will be made, for example, of reinforcing fillers, such as carbon black or silica, non-reinforcing or inert or else fibrillar fillers, colouring agents which can advantageously be used for the colouring of the composition, plasticizers other than the abovementioned extender oils, tackifying resins, protection agents, such as antioxidants or antiozonants, UV stabilizers, various processing aids or other stabilizers, or else promoters capable of promoting adhesion to the remainder of the structure of the tyre.

The use of tackifying resins may be particularly beneficial in order to adjust the softening points and also the necessary levels of adhesion of the adhesive layer or the attachment layer.

### Composition of the Attachment Layer of the Member

The composition of the attachment layer of the member has the essential feature of comprising a TPS.

The one or more block thermoplastic styrene elastomers are preferably selected such that the adhesive force, that is to say the force necessary to separate the two adhesive and attachment layers in a peel test is greater than 2 N/mm at 60° C.

According to a preferential embodiment, the thermoplastic blocks of the TPSs of the attachment and adhesive layers are compatible (that is to say similar due to their weights, their polarities or their Tg values) with the thermoplastic blocks of the block thermoplastic styrene elastomer(s) of the composition of the adhesive layer of the tyre.

The TPS(s) of the attachment layer of the member may comprise unsaturated elastomer blocks such as that/those of the adhesive layer of the tyre. However, it may also comprise saturated elastomer blocks as described above.

According to a preferential embodiment, the thermoplastic blocks of the block thermoplastic elastomer(s) of the composition of the attachment layer of the member are identical to the thermoplastic styrene blocks of the TPS(s) of the composition of the adhesive layer of the tyre.

According to a very preferential embodiment, the predominant block thermoplastic elastomers of the attachment and adhesive layers are identical.

The composition of the attachment layer of the member may also comprise saturated or unsaturated diene elastomers, in a minority amount, oils or various additives as described above.

### DESCRIPTION OF THE FIGURES

Supplementary elements of the invention are now described with the help of the appended drawing, presented nonlimitingly, in which:

FIG. 1 represents, highly schematically (without being true to a specific scale), a radial section through a tyre in accordance with one embodiment of the invention;

FIG. 2 presents, in partial radial section, a tyre blank in accordance with one embodiment of the invention;

FIG. 3 illustrates a member with an attachment layer; and

FIG. 4 shows the member attached to the surface of the tyre.

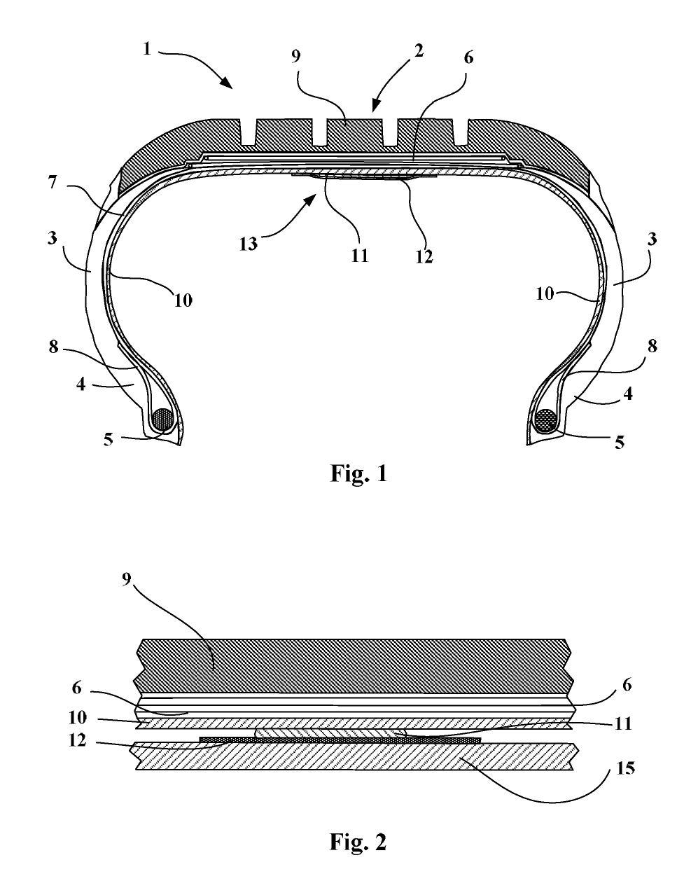

FIG. 1 schematically represents a radial section through a pneumatic tyre or tyre incorporating, at a given accommodating region 13, an adhesive layer with a protective film according to one embodiment of the invention.

This tyre 1 comprises a crown 2 reinforced by a crown reinforcement or belt 6, two sidewalls 3 and two beads 4, each of these beads 4 being reinforced with a bead wire 5. The crown reinforcement 6 is surmounted radically on the outside by a rubber tread 9. A carcass reinforcement 7 is wound around the two bead wires 5 in each bead 4, the turn-up 8 of this reinforcement 7 being, for example, arranged towards the outside of the tyre 1. The carcass reinforcement 7 is, in a way known per se, composed of at least one ply reinforced by “radial” cords, for example of textile or metal, that is to say that these cords are arranged virtually parallel to one another and extend from one bead to the other so as to form an angle of between 80° and 90° with the median circumferential plane (plane perpendicular to the axis of rotation of the tyre which is situated equidistantly from the two beads 4 and passes through the middle of the crown reinforcement 6). An airtight layer 10 extends from one bead to the other radially internally relative to the carcass reinforcement 7.

The tyre 1 is such that its inner wall comprises, in a given accommodating region 13, an adhesive layer 11. The adhesive layer 11 is covered radially internally by a protective film 12. The thickness of the adhesive layer is preferably between 0.1 and 4 mm, and very preferentially between 0.2 and 2 mm. Those skilled in the art will know how to adapt this thickness as a function of the nature, the geometry and the weight of the member and also of the thickness of the attachment layer of the member.

The surface of the accommodating region 13 and hence of the adhesive layer 11 must be sufficient to obtain robust attachment of the member; those skilled in the art will know how to adjust the dimensions of the adhesive layer as a function of the size and weight of the member to be attached.

The adhesive layer 11 consists of a predominantly styrene/isoprene/styrene SIS triblock copolymer of D1161 or D1163 grade, from Kraton.

The detachable protective film 12 is a thermoplastic film comprising, by way of example, a fluoropolymer. The thermoplastic film is extendable, with low rigidity, and has plastic behaviour. This film must have a Tg (or M.p., if appropriate) greater than the vulcanization temperature of the pneumatic tyre. An example of a suitable film is the A5000 film from Aerovac Systèmes France. This film comprises a fluorinated ethylene/propylene or FEP copolymer. This film has a maximum usage temperature of the order of 204° C. and an elongation at break of greater than 300%. The thickness thereof is 25 μm. These features enable it, in an exemplary embodiment of the invention, to be put in place directly or on the building drum of the pneumatic tyre.

As shown in FIG. 2, the protective film 12 extends beyond the accommodating region of the adhesive layer. The extension must be greater than 2 mm to guarantee that this adhesive layer does not become contaminated during the vulcanization of the tyre.

The detachable protective film 12 makes it possible to separate the adhesive layer from any contact with the building drum of the tyre then with the curing membrane of the vulcanization mould. The particular nature of this protective film enables it to be removed from the inner surface of the tyre after vulcanization. The removal of this protective film restores all the properties to the surface of the adhesive layer. The protective film 12 may be removed without tearing.

The pneumatic tyre of FIG. 1 may be manufactured, as indicated in FIG. 2, by integrating the adhesive layer into an unvulcanized tyre blank 1 using a building drum and the other techniques customary in the manufacture of pneumatic tyres. More specifically, the detachable protective film 12 arranged radially innermost is applied first to the building drum 15. The adhesive layer 11 is then put in place. All the other customary components of the pneumatic tyre are then successively applied.

After shaping, the crown plies and the tread are put in place on the tyre blank. The blank completed in this way is placed in a curing mould and vulcanized. During vulcanization, the protective film protects the curing membrane of the mould from any contact with the adhesive layer.

Upon removal from the curing mould, the protective film 12 is still attached to the adhesive layer 11.

The protective film 12 may be easily removed upon removal from the vulcanization mould of the tyre. It is also possible, and preferable, to leave this protective film in place until the member is attached.

The protective film and the adhesive layer may also be applied to the chosen accommodating region on the surface of the tyre after the shaping of the tyre blank and before the introduction thereof into the vulcanization mould.

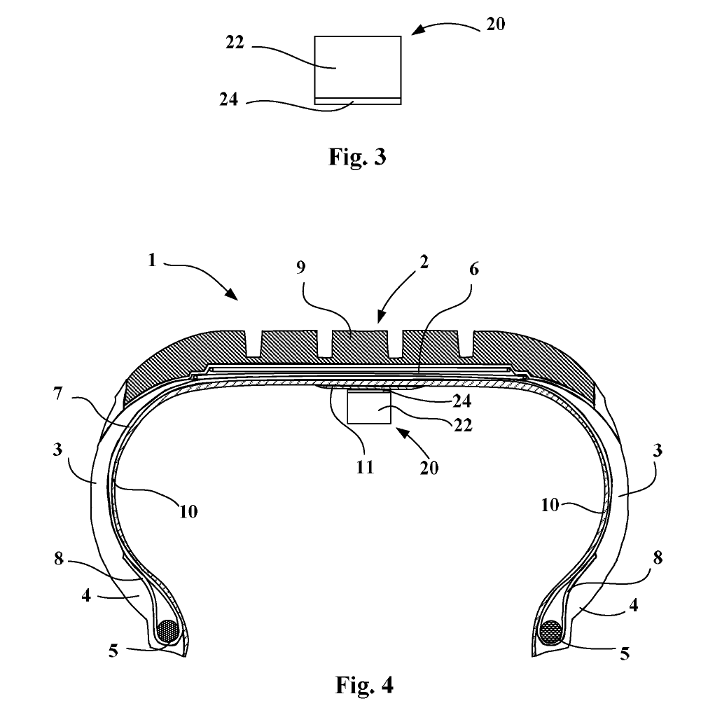

FIG. 3 schematically presents a member 20 comprising a casing 22 and an attachment layer 24. The material of the attachment layer 24 is based on a block thermoplastic elastomer, the rigid thermoplastic blocks of which are of the same nature as the rigid blocks of the TPS(s) of the adhesive layer of the tyre. The attachment layer is preferentially based on the same TPS as that of the adhesive layer. The adhesive layer and attachment layer consist of a predominantly triblock TPS based on styrene and isoprene (SIS). The thickness of the attachment layer is preferably between 0.5 and 4 mm, and very preferentially between 2 and 3 mm. Those skilled in the art will know how to adapt the thickness of the attachment layer as a function of that of the adhesive layer and of the size and weight of the member.

FIG. 4 presents the assembly of the tyre of FIG. 1 and the member 20 attached to the inner surface thereof, on the inner rubber.

The member 20 is attached to the surface of the tyre easily and rapidly:
all or a portion of the protective film 12 of the adhesive layer 11 of the tyre 1 is removed;
the adhesive layer 11 of the tyre and the attachment layer 24 of the member are heated to temperatures greater than the Tg (or M.p., if appropriate) of these block thermoplastic elastomers; this heating may be carried out by any means (hot-air blowing, infrared radiation, etc.); the surface regions of the two adhesive and attachment layers are then above their processing temperatures and are thus softened;
the attachment layer and the adhesive layer are brought into contact by applying a contact pressure; this contacting enables the two layers to interpenetrate one another due to the high molecular mobility linked to the temperature; and
contact is maintained until the two adhesive and attachment layers are cooled to below the Tg (or M.p., if appropriate) values of the TPSs.

The contact pressure is preferably greater than 0.05 bar. Those skilled in the art will know how to adjust this as a function of the attachment and adhesive layers used.

As soon as the cooling is achieved, the member is robustly attached to the surface of the tyre.

In the examples presented, the member is attached to the inner surface of the tyre; it is also possible to place it on an outer surface of the tyre, for example on the tyre sidewall.

### Tests

### Manual Peel Test

Adhesion tests (peel tests) were performed to test the capacity of the adhesive layer to adhere after curing to a diene elastomer layer, more precisely to a customary rubber composition for an inner tyre rubber (inner liner) based on butyl rubber (copolymer of isobutylene and isoprene), also comprising the customary additives (filler, sulphur, accelerator, ZnO, stearic acid, antioxidant). Of course, this test may be adapted to the case in which the member must be placed on the tyre sidewall; in this case, to produce the test specimens, a layer of rubber sidewall mixture will be used instead of a layer of customary inner rubber.

The peeling test specimens (for 180°-type peeling) were prepared by stacking the following products:

a fabric of passenger vehicle carcass ply type;

a layer of customary inner rubber (1 mm);

an SIS adhesive layer (1 mm);

a layer of customary inner rubber (1 mm); and

a fabric of passenger vehicle carcass ply type.

An incipient failure is places at the interface between one of the layers of inner rubber and the adhesive layer.

The test specimens are then vulcanized at 140° C. for 50 minutes under a pressure of 16 bar in a press comprising platens.

Strips with a width of 30 mm were cut out using a cutting machine. The two sides of the incipient failure were subsequently placed in the jaws of a tensile testing device with the Instron® brand name. The tests are performed at room temperature and at a pull speed of 100 mm/min. The tensile stresses are recorded and the latter are standardized by the width of the test specimen. A curve of strength per unit width (in N/mm) as a function of the movable crosshead displacement of the tensile testing machine (between 0 and 200 mm) is obtained. The adhesion value selected corresponds to the initiation of failure in the specimen and thus to the maximum value of this curve.

The peel measurements are carried out at room temperature and at 60° C.

### EXAMPLES

C-1 is a customary inner rubber composition;
C-2 is a reference adhesive layer without PPE;
C-3 is another reference adhesive layer without PPE;
I-1 and 1-2 are adhesive layers in accordance with the invention with different SISs and variable contents of polyphenylene ether.

TABLE 1
compositions in phr

| | Composition | | | | |
|---|---|---|---|---|---|
| | C-1 | C-2 | C-3 | I-1 | I-2 |
| Butyl elastomer (1) | 100 | | | | |
| Carbon black (N772) | 50 | | | | |
| Zinc oxide | 1.5 | | | | |
| Stearic acid | 1.5 | | | | |
| Sulphenamide (2) | 1.2 | | | | |
| Sulphur | 1.5 | | | | |
| SIS (3) | | 100 | | 100 | |
| SIS (4) | | | 100 | | 100 |
| PPE (5) | | | | 7.5 | 15 |

(1) Bromo copolymer of isobutylene and isoprene, Bromobutyl 2222, sold by Exxon Chemical Co;
(2) N-dicyclohexyl-2-benzothiazolesulphenamide (Santocure CBS from Flexsys);
(3) SIS from Kraton, reference D1161;
(4) SIS from Kraton, reference D1163;
(5) poly(2,6-dimethyl-1,4-phenylene ether) from SABIC, reference Noryl SA 120.

### Test Results

The measured adhesion values of I-1 on C-1 and of C-2 on C-1 are comparable at 20° C. but multiplied by a factor of more than 2 at 60° C. in favour of the adhesive layer comprising 7.5 phr of PPE. This result confirms the benefit of the presence of polyphenylene ether in the adhesive layer for obtaining very good adhesion of the adhesive layer based on TPS on an inner rubber.

In the case of I-2, the content of polyphenylene ether is higher and the results are broadly confirmed: at 20° C., a very substantial improvement is obtained (factor of 2) and this relative improvement is amplified at 60° C. (factor of 3). The absolute value of the adhesive forces is also noteworthy at 60° C.: 6 N/mm. This value is more than sufficient to have reliable working attachment of a member to the surface of a tyre.

TABLE 2
peel test

| | Evaluation of the adhesion | | | |
|---|---|---|---|---|
| | between the surfaces | | | |
| | C-2/ | I-1/ | C-3/ | I-2/ |
| | C-1 | C-1 | C-1 | C-1 |
| Adhesion values (N/mm) at 20° C. | 12 | 13 | 7 | 14 |
| Adhesion values (N/mm) at 60° C. | 3 | 7 | 2 | 6 |

The results of the peel tests firstly confirm the benefit of using a block thermoplastic composition put in place as described as adhesive and/or attachment layer. The adhesion values obtained are noteworthy but these values decrease significantly with the test temperature. In the presence of polyphenylene ether, an increase in the adhesive forces is observed both at room temperature and at a temperature of 60° C.

The invention thus enables rapid and reversible attachment of members to the surface of a tyre without the drawbacks linked to the preparation of the contact surface.

This attachment is reversible, that is to say that the two adhesive and attachment layers may be disassembled by heating above the Tg (or M.p., if appropriate) values of their rigid blocks, then passage of a tool. The adhesive layer uncovered in this way may then be used again to adhesively bond the same member or another.

Finally, this method of attachment affords a high degree of freedom as regards the geometry and functions of the member, due to the attachment post-vulcanization.

1.-27. (canceled)

28. A tire comprising:
a surface having an accommodating region, said surface being an inner surface, an outer surface or both an inner and an outer surface;
an adhesive layer arranged on the accommodating region; and
a protective film arranged on the adhesive layer,
wherein a composition of the adhesive layer is based on a block thermoplastic styrene (TPS) elastomer comprising a diene elastomer block with a molar content of diene units relative to all of the units of the elastomer block of greater than 10%, and
wherein the composition of the adhesive layer comprises one or more polyphenylene ethers (PPEs).

29. The tire according to claim 28, wherein the molar content of diene units of the elastomer block of the composition of the adhesive layer relative to all of the units of the elastomer block is greater than 50%.

30. The tire according to claim 28, wherein the diene units of the elastomer block are selected from the C4-C12 conjugated dienes.

31. The tire according to claim 28, wherein the diene elastomer block is a copolymer obtained by copolymerization of one or more conjugated dienes with one another or with one or more vinylaromatic compounds having from 8 to 20 carbon atoms.

32. The tire according to claim 28, wherein the diene units of the elastomer block are selected from the group consisting of butadienes, isoprenes, and mixtures thereof.

33. The tire according to claim 28, wherein the diene elastomer block is based on isoprene.

34. The tire according to claim 33, wherein the block thermoplastic styrene elastomer is a predominantly styrene/isoprene (SI) diblock copolymer.

35. The tire according to claim 33, wherein the block thermoplastic styrene elastomer is a predominantly styrene/isoprene/styrene (SIS) triblock copolymer.

36. The tire according to claim 28, wherein the one or more polyphenylene ethers has a glass transition temperature of greater than 150° C.

37. The tire according to claim 36, wherein the one or more polyphenylene ethers has a glass transition temperature of greater than 180° C.

38. The tire according to claim 36, wherein the one or more polyphenylene ethers is selected from the group consisting of poly(2,6-dimethyl-1,4-phenylene ether), poly(2,6-dimethyl-co-2,3,6-trimethyl-1,4-phenylene ether), poly-(2,3,6-trimethyl-1,4-phenylene ether), poly(2,6-diethyl-1,4-phenylene ether), poly(2-methyl-6-ethyl-1,4-phenylene ether), poly(2-methyl-6-propyl-1,4-phenylene ether), poly(2,6-dipropyl-1,4-phenylene ether), poly(2-ethyl-6-propyl-1,4-phenylene ether), poly(2,6-dilauryl-1,4-phenylene ether), poly(2,6-diphenyl-1,4-phenylene ether), poly(2,6-dimethoxy-1,4-phenylene ether), poly(1,6-diethoxy-1,4-phenylene ether), poly(2-methoxy-6-ethoxy-1,4-phenylene ether), poly(2-ethyl-6-stearyloxy-1,4-phenylene ether), poly(2,6-dichloro-1,4-phenylene ether), poly(2-methyl-6-phenyl-1,4-phenylene ether), poly(2-ethoxy-1,4-phenylene ether), poly(2-chloro-1,4-phenylene ether), poly(2,6-dibromo-1,4-phenylene ether), poly(3-bromo-2,6-dimethyl-1,4-phenylene ether), their respective copolymers and mixtures thereof.

39. The tire according to claim 38, wherein the one or more polyphenylene ether is poly(2,6-dimethyl-1,4-phenylene ether).

40. The tire according to claim 28, wherein the block thermoplastic styrene elastomer of the composition of the adhesive layer is a TPS mixture.

41. The tire according to claim 25, wherein the block thermoplastic styrene elastomer is the only elastomer of the composition of the adhesive layer.

42. The tire according to claim 28, wherein a weight content of the one or more polyphenylene ethers represents between 0.05 and 5 times the weight content of styrene present in the block thermoplastic styrene elastomer.

43. The tire according to claim 42, wherein the weight content of one or more polyphenylene ethers represents between 0.1 and 2 times the weight content of styrene present in the block thermoplastic styrene elastomer.

44. The tire according to claim 43, wherein the weight content of one or more polyphenylene ethers represents between 0.2 and 1.5 times the weight content of styrene present in the block thermoplastic styrene elastomer.

45. The tire according to claim 28, wherein the protective film is a thermoplastic film selected such that the force of peeling the film from the adhesive layer is less than 1 N/mm at 20° C.

46. The tire according to claim 45, wherein the protective film is a thermoplastic film selected such that the force of peeling the film from the adhesive layer is less than 0.5 N/mm at 20° C.

47. The tire according to claim 45, wherein the protective film is selected from the group consisting of polyesters and films comprising at least one fluoropolymer.

48. The tire according to claim 47, wherein the protective film is a film comprising at least one fluoropolymer and the at least one fluoropolymer comprises a fluorinated ethylene/propylene (FEP) copolymer.

49. The tire according to claim 28, wherein the Tg, or melting point if applicable, of the protective film is greater than the maximum curing temperature of the composition of the adhesive layer on the accommodating region.

50. A member suitable for attachment to the surface of a tire according to claim 28, wherein the member comprises an attachment layer, the composition of which is based on a block thermoplastic styrene (TPS) elastomer.

51. The member according to claim 50, wherein the composition of the attachment layer is based on a block thermoplastic styrene elastomer identical to the block thermoplastic styrene elastomer of the composition of the adhesive layer of the accommodating region of the tire.

52. The member according to claim 50, wherein block thermoplastic styrene elastomer of the attachment layer comprises an unsaturated diene elastomer block.

53. The member according to claim 50, wherein the block thermoplastic styrene elastomer of the attachment layer comprises a saturated diene elastomer block.

54. The member according to claim 50, wherein the member is a casing able to receive an electronic device.

55. The member according to claim 50, wherein the member is an electronic device.

56. A tire assembly comprising:
a tire comprising a surface having an accommodating region, said surface being an inner surface, an outer surface or both an inner and an outer surface, and an adhesive layer arranged on the accommodating region; and
the member according to claim 50,
wherein a composition of the adhesive layer is based on a block thermoplastic styrene (TPS) elastomer comprising a diene elastomer block with a molar content of diene units relative to all of the units of the elastomer block of greater than 10%, and
wherein the composition of the adhesive layer comprises one or more polyphenylene ethers (PPEs).

57. A method for attaching a member, said member comprising an attachment layer, the composition of which is based on a block thermoplastic styrene (TPS) elastomer, to a surface of a tire according to claim 28 comprising the steps of:
removing all or a portion of the protective film;
bringing the adhesive layer and the attachment layer to a temperature greater than the softening points, or melting points if applicable, of the thermoplastic blocks of the block thermoplastic styrene elastomers; and
bringing the attachment layer and the adhesive layer into contact and applying pressure thereto.
